(19) United States
(12) Patent Application Publication
(10) Pub. No.: US 2011/0267380 A1
(43) Pub. Date: Nov. 3, 2011

(54) DISPLAY APPARATUS

(75) Inventor: Kohji OHNISHI, Kobe-shi (JP)

(73) Assignee: FUJITSU TEN LIMITED, Kobe-shi (JP)

(21) Appl. No.: 13/092,635

(22) Filed: Apr. 22, 2011

(30) Foreign Application Priority Data
Apr. 28, 2010 (JP) 2010-103492
Feb. 8, 2011 (JP) 2011-025060

(51) Int. Cl. G09G 5/10

(52) U.S. Cl. 345/690

(57) ABSTRACT

A display apparatus that displays an image implements a correction to reduce a luminance of the image. Next, the display apparatus determines an amount of light of a backlight including a plurality of light sources lighting a screen, based on the reduced luminance of the image. Then, the display apparatus controls the backlight to conform to the amount of light determined based on the reduced luminance. Thus, the amount of light of the backlight is reduced. As a result, the display apparatus can reduce current consumption.

### BACKGROUND OF THE INVENTION

1. Field of the Invention

The invention relates to a technology for displaying images on a screen.

2. Description of the Background Art

Recently, energy-saving technologies have been emphasized in view of environmental affair. Display apparatuses adopting the energy-saving technologies, such as a TV set, a mobile terminal, a personal computer and a car navigation apparatus, attract much attention.

One of the energy-saving technologies adopted by these display apparatuses effectively controls a backlight included in a display apparatus to reduce significantly current consumption.

Specifically in the technology, a display apparatus including a backlight having a plurality of LEDs controls each of the amounts of light emitted by the plurality of LEDs based on the luminance of an image to be displayed on a screen.

In other words, the display apparatus controls to be smaller the amounts of light emitted by some of the LEDs lighting a low-luminance area in an image to be displayed on a screen. Japanese Patent Application Laid open Publication No. 2009-251331 discloses such a technology.

However, even the display apparatuses adopting such an energy-saving technology can not reduce current consumption in an image having less low-luminance area because the display apparatuses can not reduce the amounts of light of the backlight. In an example, an illustration image is poor in gradation and has less low-luminance area.

### SUMMARY OF THE INVENTION

According to one aspect of the invention, the display apparatus that displays an image includes a display that has a screen, a backlight that has a plurality of light sources lighting the screen, and a control system that (i) implements a correction to reduce a luminance of an image to be displayed on the display, (ii) determines an amount of light of the backlight based on the reduced luminance of the image, and (iii) controls the backlight to conform to the amount of light determined based on the reduced luminance.

Since the amount of light of the backlight is determined based on the reduced luminance of the image in a process of determination of the amount of light of the backlight based on the luminance of the image, the amount of light of the backlight can be reduced. As a result, the display apparatus can reduce current consumption.

According to another aspect of the invention, the control system implements a further correction to increase the luminance of the image after determination of the amount of light of the backlight.

Since a further correction to increase the reduced luminance of the image is implemented after determination of the amount of light lighting the screen, the display apparatus can prevent the image on the screen from becoming too dark.

According to another aspect of the invention, the control system judges whether or not the image to be displayed is an illustration image, and the control system does not implement the correction to reduce the luminance in a case where the image to be displayed is not the illustration image.

The display apparatus can prevent problems such as blackouts (clipped shadows) caused by the correction to reduce the luminance of the image in a non-illustration image which tends to be rich in gradation.

Therefore, the object of the invention is to provide a technology to reduce current consumption of a backlight included in a display apparatus even when displaying an image having less low-luminance area.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a display.

FIG. 2 shows a system configuration diagram of an on-vehicle apparatus.

FIG. 3 shows an image.

FIG. 4 shows another image.

FIG. 5 shows another image.

FIG. 6 shows a display image and a backlight state:

FIG. 7 is a figure showing luminance of an image and amounts of light of a backlight.

FIG. 8 shows a control flow implemented by the on-vehicle apparatus.

FIG. 9 is another figure showing the luminance of the image and the amounts of light of the backlight.

FIG. 10 is another figure showing the luminance of the image and the amounts of light of the backlight.

FIG. 11 shows another display image and another backlight state.

FIG. 12 shows another control flow implemented by the on-vehicle apparatus.

FIG. 13 is another figure showing the luminance of the image and the amounts of light of the backlight.

FIG. 14 is another figure showing the luminance of the image and the amounts of light of the backlight.

FIG. 15 shows another control flow implemented by the on-vehicle apparatus.

FIG. 16 shows another display image and another backlight state.

FIG. 17 is another figure showing the luminance of the image and the amounts of light of the backlight.

FIG. 18 is another figure showing the luminance of the image and the amounts of light of the backlight.

FIG. 19 shows another control flow implemented by the on-vehicle apparatus.

FIG. 20 shows another display image and another backlight state.

FIG. 21 shows another display image and another backlight state.

### DESCRIPTION OF THE EMBODIMENTS

The following technology is adopted by various display apparatuses equipped with a display. However, for the sake of convenience, only an on-vehicle apparatus is described concretely. Here, a configuration of a display for the on-vehicle apparatus, a configuration of the on-vehicle apparatus, and controls implemented by the on-vehicle apparatus are separately described with reference to the attached drawings.

### First Embodiment

<Configuration of Display for On-Vehicle Apparatus>

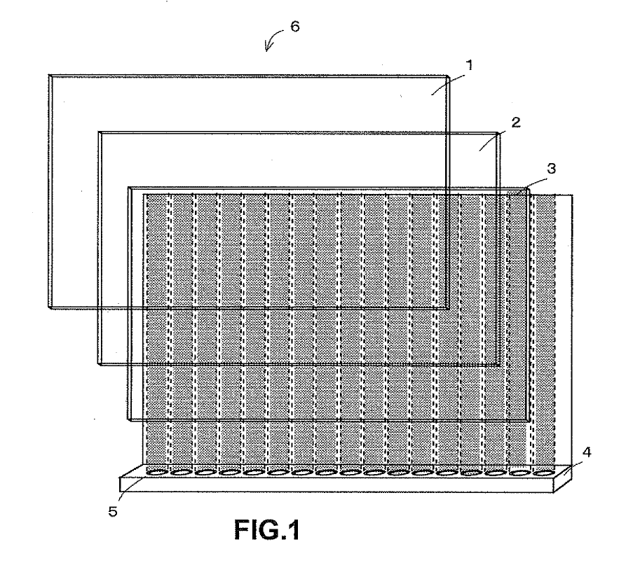

The configuration of a display included in an on-vehicle apparatus to be installed in a vehicle is described based on FIG. 1. A display 6 includes a color filter 1, a liquid crystal layer 2, a TFT (Thin Film Transistor) 3, and a backlight 4.

The color filter 1 is a film on which three primary colors (ROB) are printed on each pixel.

The liquid crystal layer 2 has a function in which molecular arrangement of liquid crystal is changed when voltage is applied from the outside. The liquid crystal layer 2 can be called a crystal shutter.

The TFT 3 is a thin film transistor including electrodes disposed in a matrix. When an image controller controls electrical current to flow into those electrodes, a voltage generated in cells disposed in a matrix on the TFT 3 changes the molecular arrangement of liquid crystal corresponding to the cells, in the liquid crystal layer 2.

That is, the TFT 3 has a function of displaying a color corresponding to the part where light of the backlight 4 passes through the color filter 1 to its front side.

The backlight 4 includes a plurality of LEDs (Light Emitting Diodes) 5 disposed in series to be used as light sources.

The display 6 includes the color filter 1, the liquid crystal layer 2 and the TFT 3, and the screen of the display 6 is lighted by the backlight 4.

The backlight 4 is an edge light type in a simple structure, which requires a thinner display in structure. That is, the backlight 4 of this edge light type has the most appropriate structure for an on-vehicle apparatus that is required for downsizing.

The backlight 4 of the edge light type includes the plurality of LEDs 5 to be used as light sources, which are disposed in series near the base line (bottom base) of the display 6 in a rectangular shape. Thus, on the display 6, the closer to an opposite side of the base line (upper base) the light travels, the weaker the light becomes. To avoid this issue, the backlight 4 includes a polarizer that functions to spread light of the backlight 4 evenly on the display 6.

The backlight 4 not only can control the LEDs 5 included in the backlight 4 by a simple control of light emission on or off, but also can control the amount of light of each of the LEDs 5 by providing control current in different duty proportions to each of the LEDs 5.

Images such as car navigation images used by a car navigation apparatus and digital TV images can be displayed on the screen of the display 6, when an image controller of the on-vehicle apparatus controls the TFT 3 and the backlight 4 of the display 6 which includes the color filter 1, the liquid crystal layer 2, the TFT 3 and the backlight 4 in layers.

<Configuration of On-Vehicle Apparatus>

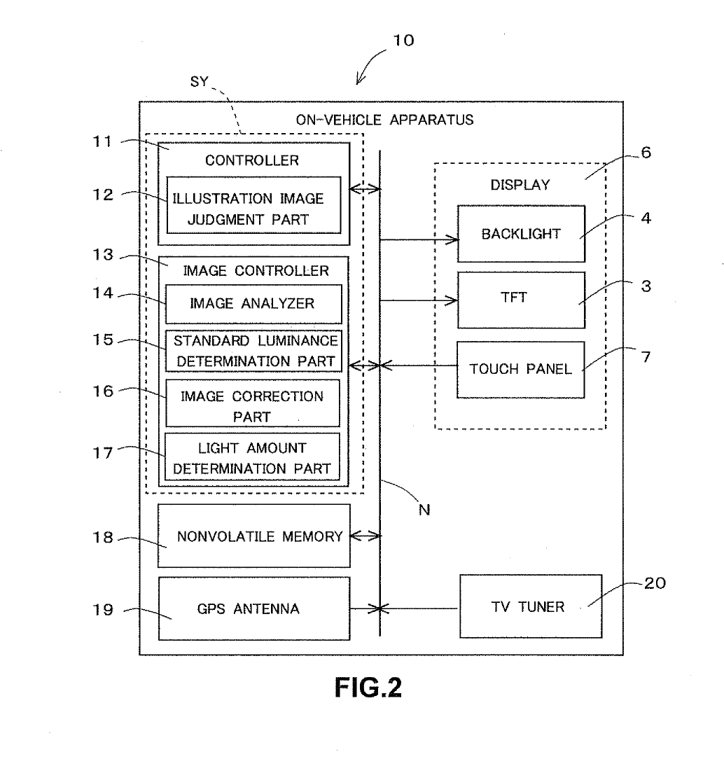

Next, the configuration of an on-vehicle apparatus 10 is described based on FIG. 2. The on-vehicle apparatus 10 functions as a car navigation apparatus that navigates a car by providing route information to a destination. The on-vehicle apparatus 10 includes a controller 11, an image controller 13, a nonvolatile memory 18, a GPS antenna 19, a TV tuner 20 and the display 6, which are connected electrically to a bus N supporting data communication.

The controller 11 is a microcomputer that includes a CPU and a ROM storing control programs and the like. In an example, an illustration image judgment part 12 included in the controller 11 has a function of judging an illustration image. The function is to judge whether or not an image inputted into the image controller 13 is an illustration image. Details of the function of illustration image judgment are described later.

The image controller 13 is an LSI (Large Scale Integration). In an example, an image analyzer 14, a standard luminance determination part 15, an image correction part 16 and a light amount determination part 17 are included in the image controller 13 and have respective functions of image analyzing, standard luminance determination, image correction and light amount determination.

The image analyzing is a function where image analyzer 14 analyzes an image to be displayed on the display 6. The standard luminance determination is a function where standard luminance determination part 15 determines standard luminance of an inputted image. The image correction is a function where the image correction part 16 corrects an image, based on the standard luminance of the image and the amount of light. The light amount determination is a function where the light amount determination part 17 determines the amount of light emitted from the backlight 4. These functions of image analyzing, standard luminance determination, light amount determination and image correction are described later in particular.

The image controller 13 also has a function of displaying an image on the screen of the display 6 by controlling the TFT 3, and a function of lighting the screen of the display 6 by controlling the backlight 4.

A combined system of the controller 11 and the image controller 13 is a control system SY. The nonvolatile memory 18 is, for example, a flash memory such as EEPROM, and stores data relating to a car navigation image and other data. The data relating to a car navigation image are a map image, an own-vehicle position mark and a direction mark, for example.

The GPS antenna 19 is an antenna for receiving from GPS satellites GPS data that indicates where the vehicle equipped with the on-vehicle apparatus 10 is on the earth.

The TV tuner 20 has a function of demodulating the received data of digital TV broadcasting into prescribed data.

The display 6 includes the backlight 4 and the TFT 3 as described above. The display 6 also includes a touch panel 7 that receives a user operation on its display screen.

<Control by On-Vehicle Apparatus>

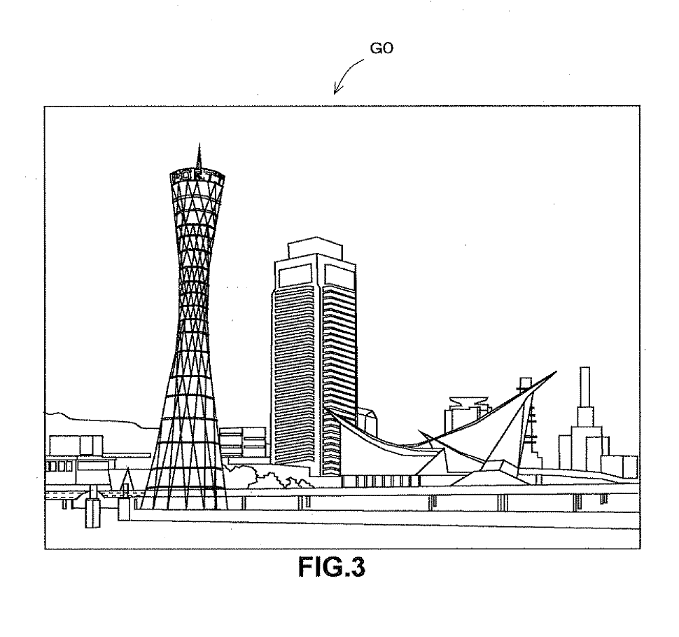

The image controller 13 displays on the display 6 a TV image G0 received via the TV tuner 20 as shown in FIG. 3, after receiving a user operation of setting a TV mode via the touch panel 7 of the display 6.

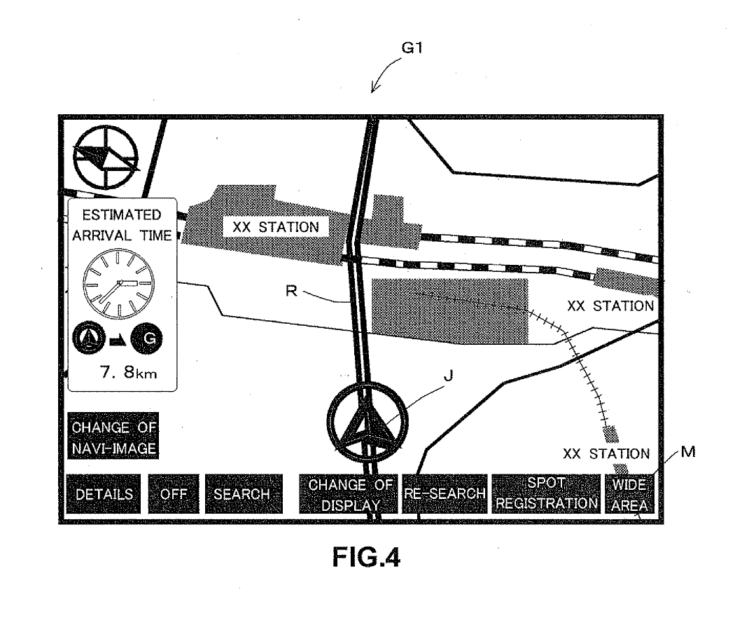

The image controller 13 also displays on the display 6 a car navigation image G1 which includes an own-vehicle position mark J, a selection mark M for receiving an operation to implement a prescribed function, and a map image, which are read out from the nonvolatile memory 18 based on the GPS data received via the GPS antenna 19, after receiving a user operation of setting a car navigation mode via the touch panel 7 of the display 6, as shown in FIG. 4.

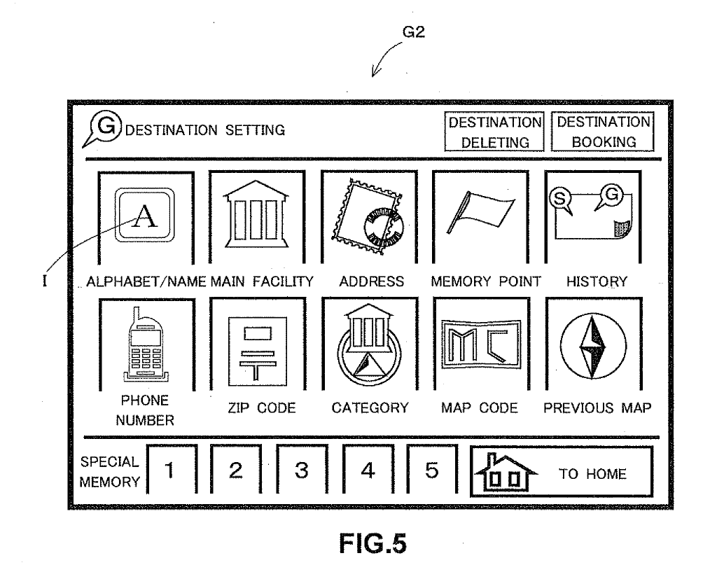

Further, the image controller 13 displays on the display 6 a menu image G2 shown in FIG. 5, after receiving a user operation of setting a menu mode via the touch panel 7 of the display 6. The menu image includes marks for receiving operations to implement various functions.

The illustration image is an image formed by a picture or a figure, and is, for example, the car navigation image G1 and the menu image G2. That is, the illustration image judgment part 12 of the controller 11 judges that the image to be inputted is an illustration image when receiving a user operation to set the car navigation mode or the menu mode via the touch panel 7 of the display 6, among the three user's operations to set the TV mode, the car navigation mode and the menu mode. Here, the embodiment is the case where the car navigation image G1 is set.

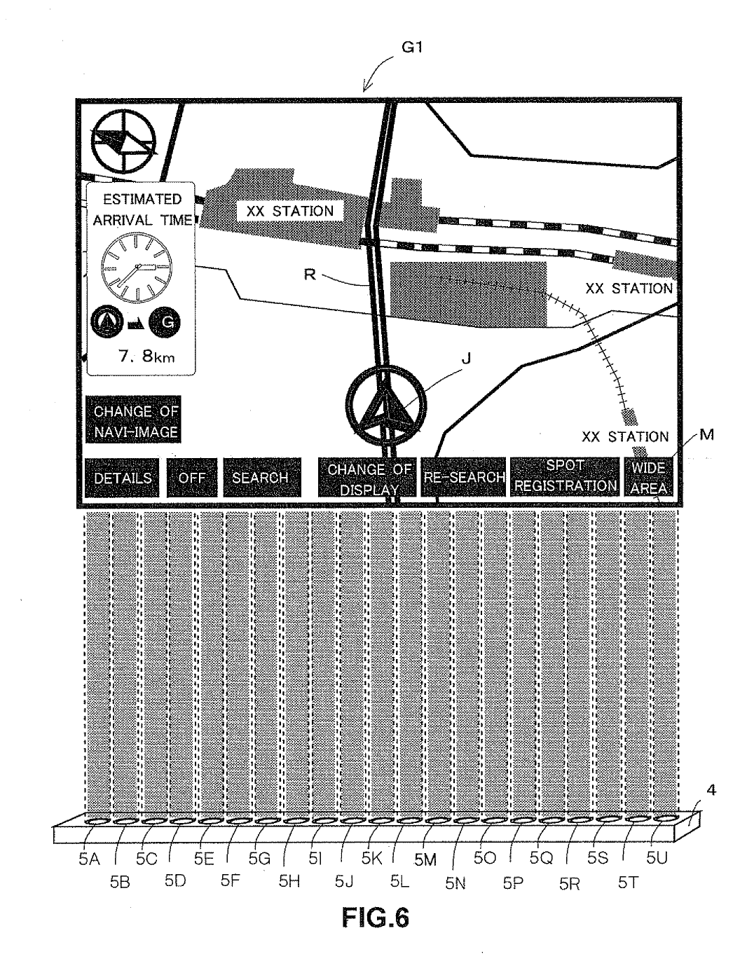

Further, the image controller 13 provides a user-selectable eco mode that consumes lower power on the menu screen G2 and the car navigation image G1. The image controller 13 functions in a normal mode where all of the LEDs 5 included in the backlight 4 emit light evenly, as shown in FIG. 6, in the case where a user does not select the eco mode.

Here is a description of the normal process of the controller 11 to make all of the LEDs 5 emit light. For explanatory convenience, addresses are allocated to the respective LEDs 5 in such a manner that a LED 5A is for the first left, a LED 5B for the second left, a LED 5C for the third left, etc., as in FIG. 6.

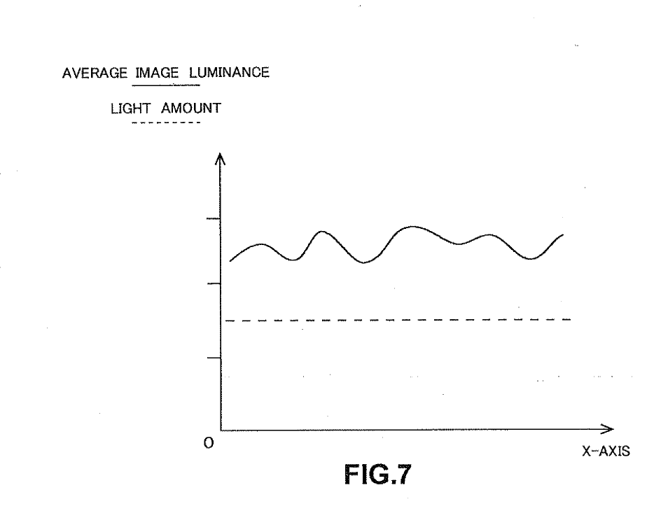

In the normal mode, the standard luminance determination part 15 derives an average luminance of the image (hereinafter, referred to as average image luminance) of pixels on the inputted car navigation image G1 when implementing the normal process, and determines an amount of light to be emitted by the backlight 4 based on the derived average image luminance. Concretely, the light amount determination part 17 determines an even amount of light based on the average image luminance, as shown in FIG. 7.

In FIG. 7, a horizontal axis shows a horizontal position of the screen of the display 6 and a vertical axis shows a level, in the normal process. A solid line shows average image luminance of the vertical direction at each horizontal position in an image displayed on the screen, and a dashed line shows an amount of light of the backlight 4. Thus, according to FIG. 7, the amount of light of the backlight 4 that corresponds to the average image luminance of the vertical direction at each horizontal position in an image displayed on the screen is seen.

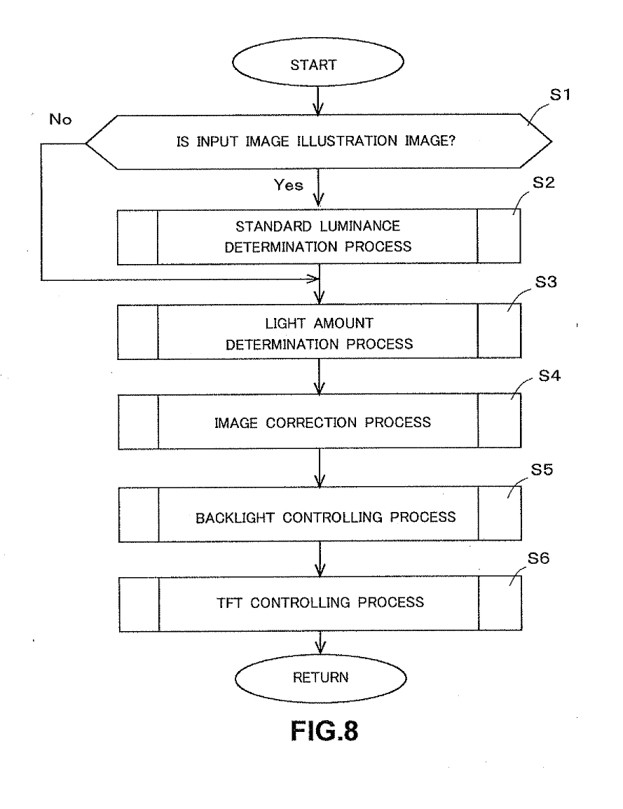

Meanwhile, the on-vehicle apparatus 10 implements the control flow shown in FIG. 8 for displaying the initial car navigation image G1.

Further, the on-vehicle apparatus 10 keeps implementing the control flow at predetermined intervals, from the time of updating of the car navigation image G1 unless a user turns off the power of the on-vehicle apparatus 10 or selects other functions such as the display of TV broadcasting.

The controller 11 updates the display of the car navigation image G1 at the times when an own-vehicle position obtained via the GPS antenna 19 moves by a prescribed distance or more and when vehicle velocity obtained via a vehicle-velocity sensor installed on the vehicle changes by a prescribed amount or more, and at other occasions.

Hereafter, the control flow in FIG. 8 implemented by the on-vehicle apparatus 10 is described. This control flow is implemented when a user selects the eco mode.

In the step S1, the illustration image judgment part 12 judges whether or not the inputted image is an illustration image (a step S1).

When the illustration image judgment part 12 judges that the image to be displayed is an illustration image (Yes at the step S1), the process moves to a step S2. When the illustration image judgment part 12 does not judge that the image to be displayed is an illustration image (No at the step S1), the process moves to a step S3.

The description of the processes for display after the process moved to the step S3 in the case of “No” at the step S1 is omitted here because the process are the normal processes described above.

In the step S2, the standard luminance determination part 15 determines standard image luminance used as a standard at the time when the light amount determination part 17 determines the amount of light of the backlight 4.

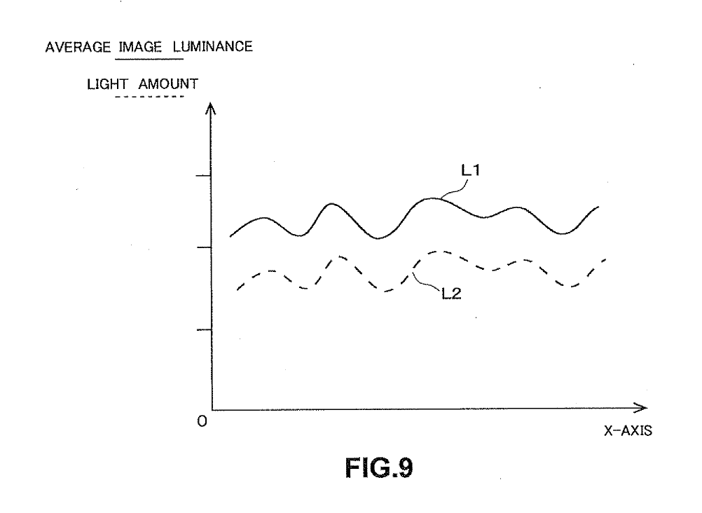

Concretely, the standard luminance determination part 15 derives an average image luminance L1 of the vertical direction at each horizontal position on the car navigation image G1 displayed on the screen of the display 6, as shown in FIG. 9. Next, the process moves to the step S3.

In the step S3, the light amount determination part 17 determines a light amount L2 based on the average image luminance L1 determined by the standard luminance determination part 15.

Concretely, the light amount determination part 17 derives the light amount L2 using the average image luminance L1 as a search key from a map where the average image luminance L1 and the light amount L2 are linked, the map being stored in a memory included in the on-vehicle apparatus 10 (first search process).

The light amount L2 is a control amount for controlling the LEDs 5 corresponding to each position on the horizontal direction (X-axis direction) on the car navigation image G1 to be displayed on the screen of the display 6, as shown in FIG. 9.

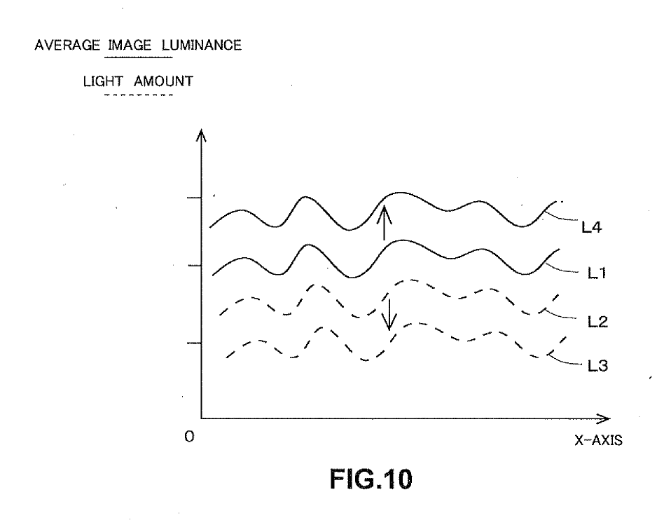

Further, the light amount determination part 17 determines a light amount L3 derived after reduction by a predetermined proportion (e.g. 5%) from the determined light amount L2, as shown in FIG. 10.

Concretely, the light amount determination part 17 derives the light amount L3 using the light amount L2 as a search key from a map where the light amount L2 and the light amount L3 are linked, the map being stored in the memory included in the on-vehicle apparatus 10 (second search process).

Here, the two processes to be implemented by the light amount determination part 17, the first search process and the second search process, may be integrated into one process.

That is, the light amount determination part 17 determines the light amount L3 based on the average image luminance L1 determined by the standard luminance determination part 15, as shown in FIG. 10.

Concretely, the light amount determination part 17 derives the light amount L3 using the average image luminance L1 as a search key from a map where the average image luminance L1 and the light amount L3 are linked, the map being stored in the memory included in the on-vehicle apparatus 10.

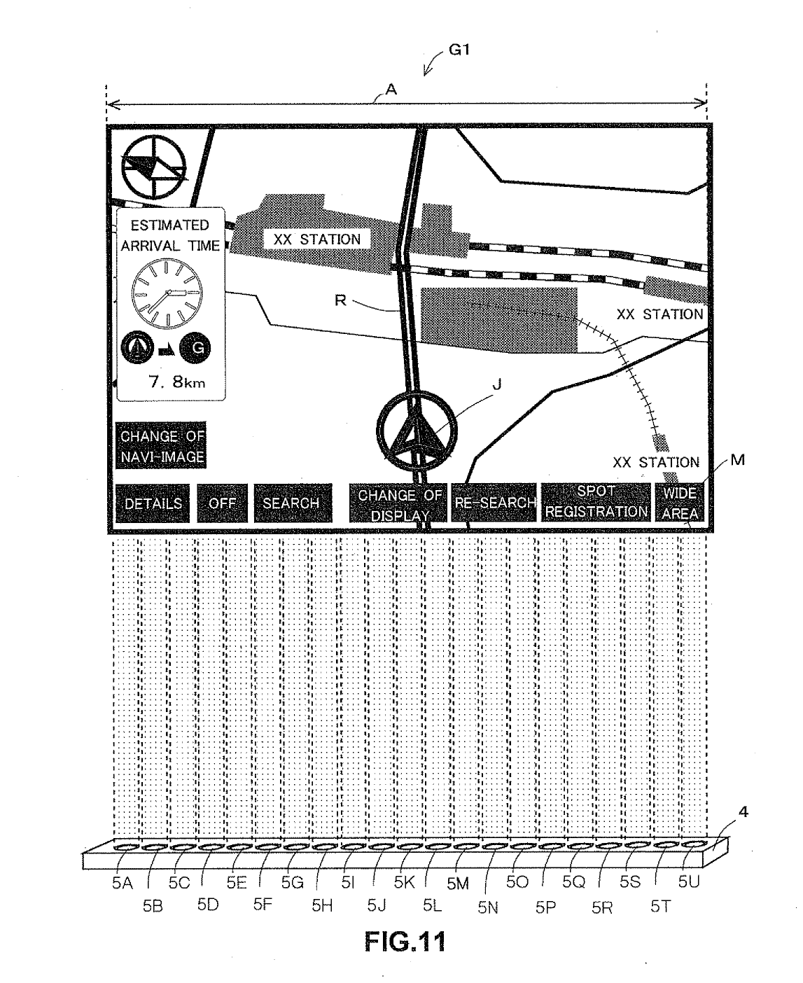

That is, the light amount determination part 17 determines at the value of the light amount L3 the control amount for each of the amounts of light of the LEDs 5 from the LED 5A to the LED 5U included in the backlight 4, as shown in FIG. 11. Next, the process moves to a step S4.

In the step S4, the image correction part 16 determines an average image luminance L4 based on the light amount L3 determined by the light amount determination part 17, as shown in FIG. 10.

Concretely, the image correction part 16 derives the average image luminance L4 using the light amount L3 as a search key from a map where the light amount L3 and the average image luminance L4 are linked, the map being stored in the memory included in the on-vehicle apparatus 10 (third search process).

The map is formed so that an image can provide visibility like the original car navigation image G1 as a whole, by increasing the luminance of the image, corresponding to the reduction in the amount of light from the light amount L2 to the light amount L3, based on the respective functions of the image controller 13.

Further, since the average image luminance L4 is the average image luminance of the vertical direction at each position on the horizontal direction (X-axis direction) on the car navigation image G1 to be displayed on the screen of the display 6, the image correction part 16 needs to correct the luminance allotted to each of a plurality of pixels of the vertical direction based on the average image luminance L4 of the vertical direction (average image luminance correction).

Thus, the image correction part 16 implements correction on each of the plurality of pixels of the vertical direction in such a manner that, when the luminance is low based on the average image luminance L4, the luminance is increased by a predetermined proportion (%) which is corresponding to the differential, and when luminance is high based on the average image luminance L4, the luminance is reduced by a predetermined proportion (%) which is corresponding to the differential. Next, the process moves to a step S5.

In the step S5, the image controller 13 controls the plurality of LEDs 5 included in the backlight 4 based on the amount of light determined by the light amount determination part 17.

That is, the image controller 13 controls the LEDs 5 from the LED 5A to the LED 5U included in the backlight 4 at the value of the light amount L3, as shown in FIG. 11. Next, the process moves to a step S6.

In the step S6, the image controller 13 controls the TFT 3 based on the luminance of the car navigation image G1 corrected by the image correction part 16.

That is, the image controller 13 makes the light of the backlight 4 pass through one of the three RGB primary colors printed on each of the pixels of the color filter 1 by controlling the TFT so that the display 6 displays the car navigation image G1. Next, the process moves to a return.

As above, the on-vehicle apparatus 10 upgrades the visibility for a user by correcting the luminance of an image while reducing the amounts of light of the backlight 4. Thus, the on-vehicle apparatus 10 succeeds in reducing current consumption regarding the car navigation image G1, while fulfilling the car navigation function using the car navigation image G1.

Each of the plurality of LEDs 5 included in the backlight 4 of an edge light type emits light in a sector shape actually. However, figures such as FIG. 11 indicate the light traveling substantially in line abstracted showing only the stronger part of the light emitted from each of the LEDs 5.

### Second Embodiment

So far, the first embodiment was described. Next, a second embodiment that reduces further current consumption is described. Hereafter, the second embodiment is described centering on the part different from the first embodiment because an on-vehicle apparatus 10 of the second embodiment has a similar structure with that of the first embodiment.

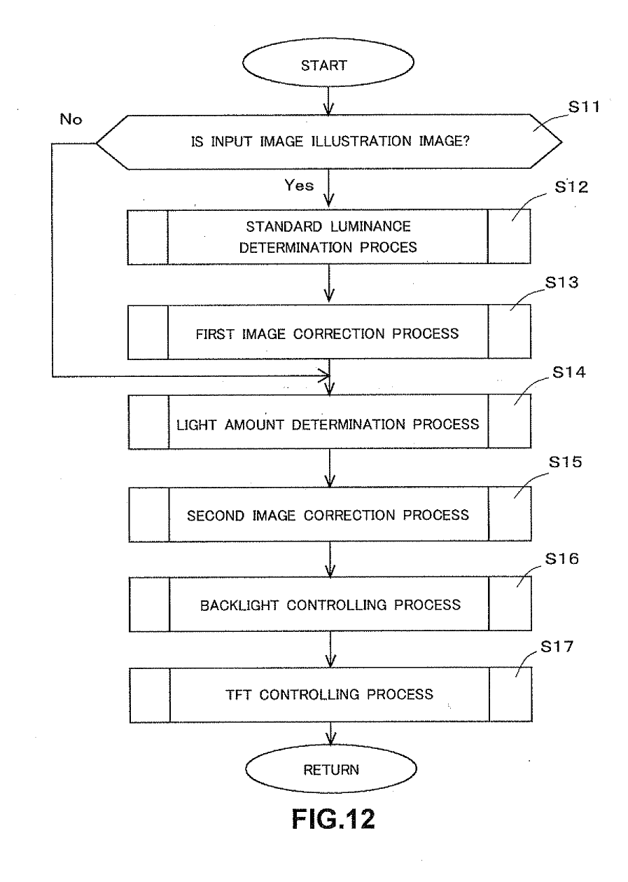

First, in a step S11 of FIG. 12, an illustration image judgment part 12 of a controller 11 judges whether or not an image to be displayed on a display 6 is an illustration image (the step S11).

When the image to be displayed is an illustration image (Yes at the step S11), the process moves to a step S12. When the image to be displayed is not judged as an illustration image (No at the step S11), the process moves to a step S14 without implementing the step S12 and a step S13. That is, when the image to be displayed is not judged as an illustration image, the processes of the step S12 and the step S13 are prohibited.

The description of the processes for display after the process moves to the step S14 in the case of “No” (when the image to be displayed is not judged as an illustration image) at the step S11 is omitted here because the processes are the same as the normal processes described above. The processes in the case of “Yes” at the step S1 in FIG. 8 for the first embodiment may be implemented as the following processes of the normal processes.

In the step S12, a standard luminance determination part 15 derives a standard luminance of an image (hereinafter, referred to as standard value) used as a standard at the time when a light amount determination part 17 determines the amount of light of a backlight 4.

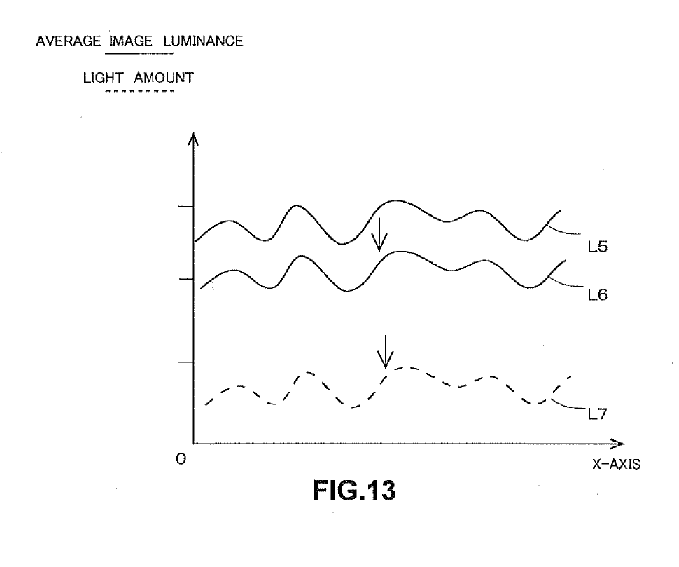

Concretely, the standard luminance determination part 15 derives an average image luminance L5 of the vertical direction at each horizontal position on a car navigation image G1 to be displayed on the screen of the display 6, as shown in FIG. 13. Next, the process moves to the step S13.

In the step S13, an image correction part 16 implements a first-image-correction process. That is, the image correction part 16 corrects luminance of the image to an average image luminance L6 by reducing the average image luminance L5 used as a standard value by a predetermined proportion (e.g. 5%) shown in FIG. 13.

Concretely, the image correction part 16 derives the average image luminance L6 using the average image luminance L5 as a search key from a map where the average image luminance L5 and the average image luminance L6 are linked, the map being stored in a memory included in the on-vehicle apparatus 10 (fourth search process).

That is, since the image correction part 16 lowers the luminance of the car navigation image G1 compared to the original luminance of the image, which is used as a standard when the light amount determination part 17 determines the amount of light, the on-vehicle apparatus 10 succeeds in reducing current consumption. Next, the process moves to the step S14.

In the step S14, the light amount determination part 17 determines a light amount L7 based on the average image luminance L6 corrected by the image correction part 16, as shown in FIG. 13.

Concretely, the light amount determination part 17 derives the light amount L7 using the average image luminance L6 as a search key from a map where the average image luminance L6 and the light amount L7 are linked, the map being stored in the memory included in the on-vehicle apparatus 10 (fifth search process).

The light amount L7 is a control amount for controlling a plurality of LEDs 5 corresponding to each position on the horizontal direction (X-axis direction) on the car navigation image G1 to be displayed on the screen of the display 6, as shown in FIG. 13.

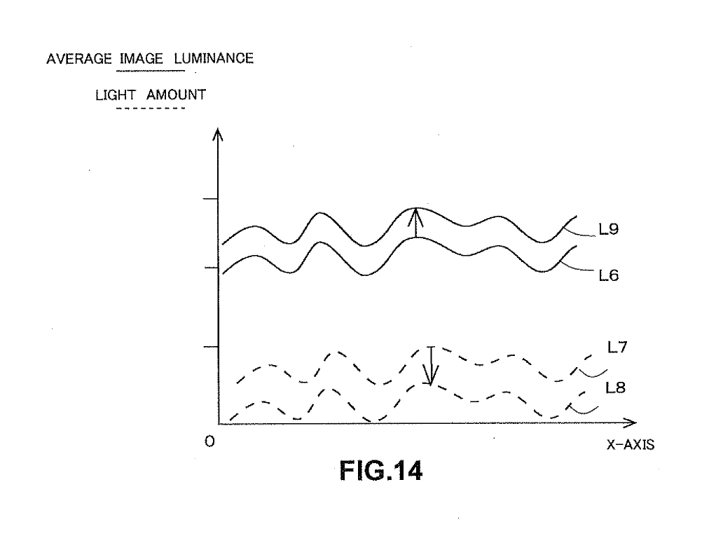

Further, the light amount determination part 17 determines a light amount L8 derived after reduction by a predetermined proportion (e.g. 5%) from the determined light amount L7 of each of the LEDs 5, as shown in FIG. 14.

Concretely, the light amount determination part 17 derives the light amount L8 using the light amount L7 as a search key from a map where the light amount L7 and the light amount L8 are linked, the map being stored in the memory included in the on-vehicle apparatus 10 (sixth search process).

Here, the two processes to be implemented by the light amount determination part 17, the fifth search process and the sixth search process, may be integrated into one process. That is, the light amount determination part 17 may determine the light amount L8 of each of the LEDs 5 based on the average image luminance L6 at each position on the horizontal axis on the car navigation image G1 corrected by the image correction part 16, as shown in FIG. 14.

Concretely, the light amount determination part 17 derives the light amount L8 using the average image luminance L6 as a search key from a map where the average image luminance L6 and the light amount L8 are linked, the map being stored in the memory included in the on-vehicle apparatus 10.

That is, the light amount determination part 17 determines at the value of the light amount L8 the control amount for the amount of light of each of the LEDs 5 from the LED 5A to the LED 5U included in the backlight 4. Next, the process moves to a step S15.

In the step S15, the image correction part 16 implements the second-image-correction process. That is, the image correction part 16 determines an average image luminance L9 at each position on the horizontal axis on the car navigation image G1 based on the light amount L8 of each of the LEDs 5 determined by the light amount determination part 17, as shown in FIG. 14.

Concretely, the image correction part 16 derives the average image luminance L9 using the light amount L8 as a search key from a map where the average image luminance L9 and the light amount L8 are linked, the map being stored in the memory included in the on-vehicle apparatus 10 (seventh search process).

The map is formed so that an image can provide visibility like the original car navigation image G1 as a whole by increasing the luminance of the image, corresponding to the reduction in the amount of light from the light amount L7 to the light amount L8, based on the respective functions of an image controller 13.

Further, since the average image luminance L9 is the average image luminance of the vertical direction at each position on the horizontal direction (X-axis direction) on the car navigation image G1 displayed on the screen of the display 6, the image correction part 16 needs to correct the luminance allotted to each of the pixels of the vertical direction based on the average image luminance L9 of the vertical direction (average image luminance correction).

Thus, the image correction part 16 implements correction on each of the pixels of the vertical axis at each position on the horizontal axis on the car navigation image G1 in such a manner that, when the luminance is low based on the average image luminance L9 corresponding to each of the pixels, the luminance is increased by a predetermined proportion (%) which is corresponding to the differential, and when the luminance is high based on the average image luminance L9, the luminance is reduced by a predetermined proportion (%) which is corresponding to the differential. Next, the process moves to a step S16.

In the step S16, the image controller 13 controls the amounts of light of the plurality of LEDs 5 included in the backlight 4 based on the amount of light determined by the light amount determination part 17.

That is, the image controller 13 controls each of the LEDs 5 included in the backlight 4 from an LED 5A to an LED 5U as shown in FIG. 11, at the value of the light amount L8 corresponding to each of the LEDs 5. Next, the process moves to a step S17.

In the step S17, the image controller 13 controls a TFT 3 to display the car navigation image G1 corrected by the image correction part 16 on the display 6. That is, the image controller 13 makes the light of the backlight 4 pass through one of the three RGB primary colors printed on each of pixels of a color filter 1 by controlling the TFT so that the display 6 displays the car navigation image G1. Next, the process moves to a return.

As above, the second embodiment succeeds in reducing largely the current consumption of the backlight 4 because the amount of light of the backlight 4 is determined based on the car navigation image G1 whose image luminance has been reduced.

Since the luminance of the image is increased for correction after the luminance of the image is reduced and also the amount of light of a screen is reduced, the second embodiment also succeeds in preventing the state where an image displayed on a screen becomes too dark.

As for a non-illustration image that tends to be rich in gradation, such as a general picture image, the second embodiment can prevent occurrence of many blackouts (clipped shadows) by prohibiting the reduction process of the luminance of the image at the step S13.

### Third Embodiment

So far, the second embodiment was described. Next a third embodiment that reduces current consumption much further is described. Hereafter, the third embodiment is described centering on the part different from the second embodiment because an on-vehicle apparatus 10 of the third embodiment and that of the second embodiment are of substantially the same structure.

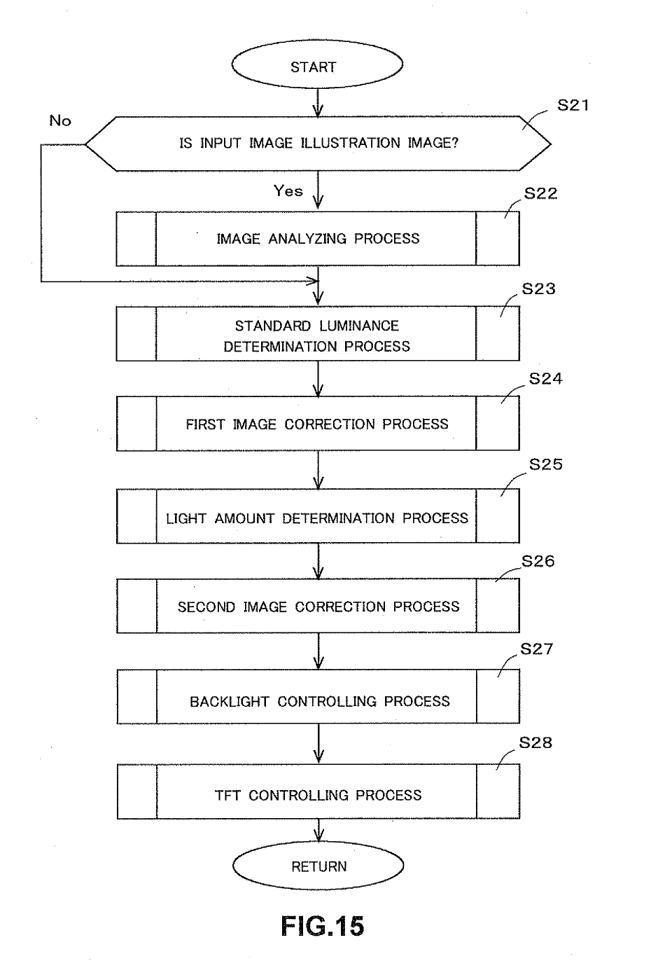

First, in a step S21 of FIG. 15, an illustration image judgment part 12 of a controller 11 judges whether or not the inputted image is an illustration image (the step S21).

When the image to be displayed is judged as an illustration image (Yes at the step S21), the process moves to a step S22. When the image to be displayed is not judged as an illustration image (No at the step S21), the process moves to a step S23.

The description of the processes for display after the process moves to the step S23 in the case of “No” at the step S21 is omitted here because the processes are the normal processes described above. The processes when “Yes” is judged at the step S1 for the first embodiment may be implemented as the normal processes in this case.

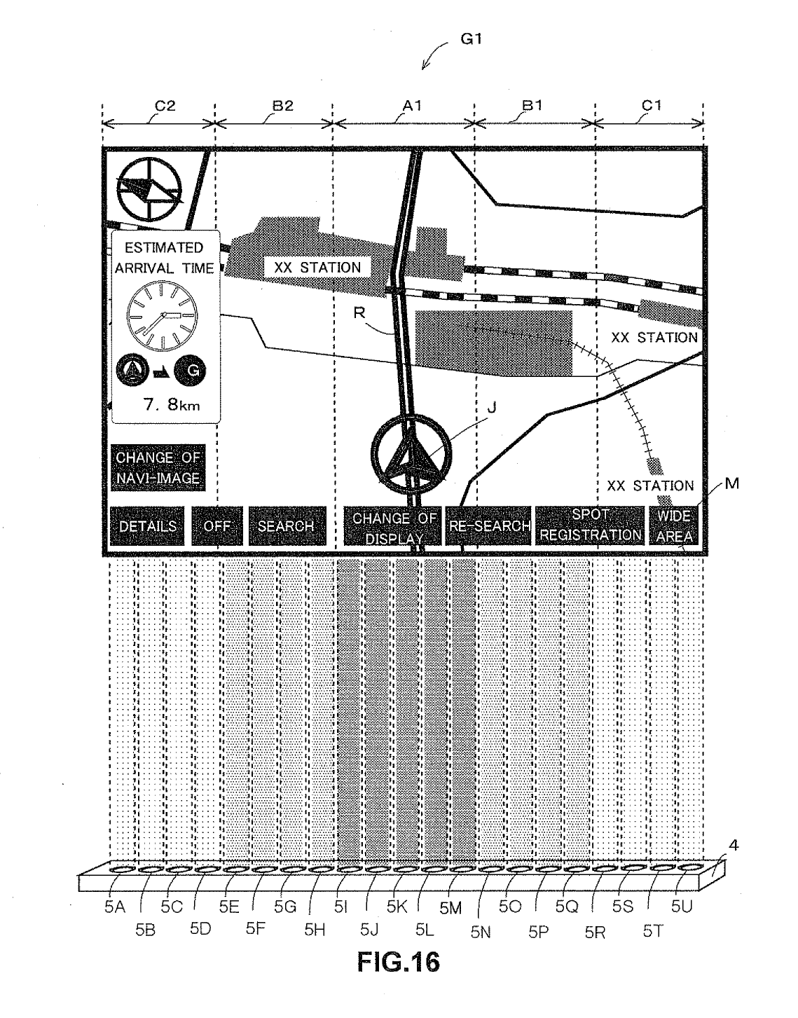

In the step S22, an image analyzer 14 judges where an own-vehicle position mark J included in a car navigation image G1 is displayed on the car navigation image G1, and specifies a first area A1 in a constant width centered on the own-vehicle position mark J, as shown in FIG. 16.

Further, the image analyzer 14 specifies a second area B1 and a second area 132 being of substantially the same width as the first area A1 on the car navigation image G1, as shown in FIG. 16. The second area B1 is located on the right side of the first area A1 and the second area B2 is located on the left side of the first area A1 on the image in which a traveling direction pointed by the own-vehicle position mark J is up.

The image analyzer 14 also specifies a third area C1 and a third area C2 being of substantially the same width as the first area A1 on the car navigation image G1, as shown in FIG. 16. The third area C1 is located on the right side of the second area B1 and the third area C2 is located on the left side of the second area B2.

On the car navigation image G1 shown in FIG. 16, the traveling direction pointed by the own-vehicle position mark J is always up (i.e. in head-up display system) on the screen of a display 6. Next, the process moves to the step S23.

In the step S23, a standard luminance determination part 15 derives a standard image luminance (hereinafter, referred to as standard value) used as a standard at the time when a light amount determination part 17 determines the amount of light of a backlight 4.

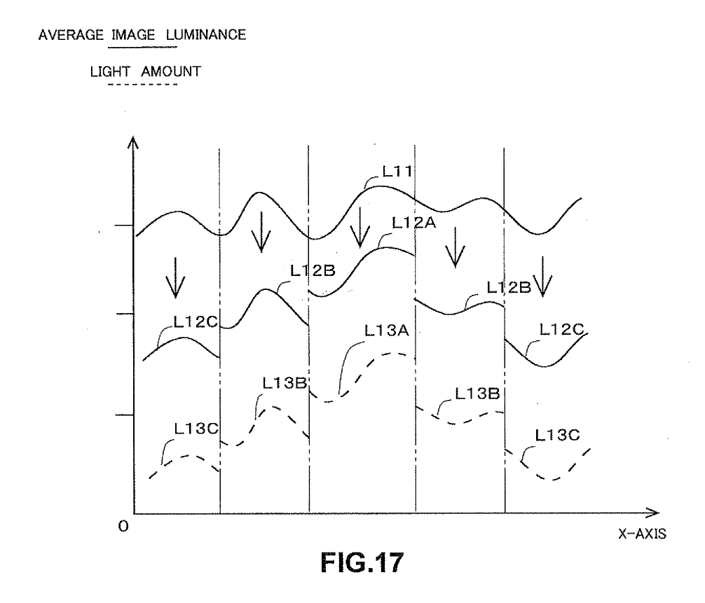

Concretely, the standard luminance determination part 15 derives an average image luminance L11 of the vertical direction at each horizontal position on the car navigation image G1 displayed on the screen of the display 6, as shown in FIG. 17. In this case, the average image luminance L11 is the standard value. Next, the process moves to a step S24.

In the step S24, an image correction part 16 implements a part of a first-image-correction process. That is, the image correction part 16 implements correction so that the average image luminance of the first area A1 conforms to the value of an average image luminance L12A that is a predetermined proportion (e.g. 3%) lower than the average image luminance L11 used as the standard value.

Concretely, the image correction part 16 derives the average image luminance L12A using the average image luminance L11 as a search key from a map where the average image luminance L11 and the average image luminance L12A are linked, the map being stored in the memory included in the on-vehicle apparatus 10 (eighth search process).

Further, the image correction part 16 implements another part of the first-image-correction process. The image correction part 16 reduces the image luminance of the second area B1 and the second area B2 so that a reduction amount of the image luminance of the second area B1 and the second area B2 becomes greater than that of the first area A1. That is, the image correction part 16 implements correction so that the average image luminance of the second area B1 and of the second area B2 conform to the value of an average image luminance L12B that is a predetermined proportion (e.g. 6%) lower than the average image luminance L11 used as the standard value.

Concretely, the image correction part 16 derives the average image luminance L12B using the average image luminance L11 as a search key from a map where the average image luminance L11 and the average image luminance L12B are linked, the map being stored in the memory included in the on-vehicle apparatus 10 (ninth search process).

Further, the image correction part 16 implements another part of the first-image-correction process. The image correction part 16 reduces the image luminance of the third area C1 and the third area C2 so that a reduction amount of the image luminance of the third area C1 and the third area C2 becomes greater than that of the second area B1 and the second area B2. That is, the image correction part 16 implements correction so that the average image luminance of the third area C1 and of the third area C2 conform to the value of an average image luminance L12C that is a predetermined proportion (e.g. 9%) lower than the average image luminance L11 used as the standard value.

Concretely, the image correction part 16 derives the average image luminance L12C using the average image luminance L11 as a search key from a map where the average image luminance L11 and the average image luminance L12C are linked, the map being stored in the memory included in the on-vehicle apparatus 10 (tenth search process). Next, the process moves to a step S25.

In the step S25, the light amount determination part 17 determines a light amount L13A, a light amount L13B, and a light amount L13C of each of a plurality of LEDs 5 based on the average image luminance L12A, the average image luminance L12B and the average image luminance L12C corrected by the image correction part 16, as shown in FIG. 17.

Concretely, the light amount determination part 17 derives the light amount L13A, the light amount L13B and the light amount L13C using the average image luminance L12A, the average image luminance 12B and the average image luminance 12C as search keys from a map where the average image luminance and amounts of light are linked, the map being stored in the memory included in the on-vehicle apparatus 10 (eleventh search process).

The light amount L13A, the light amount L13B and the light amount L13C are control amounts for controlling each of the LEDs 5 corresponding to the position on horizontal direction (X-axis direction) on the car navigation image G1 to be displayed on the screen of the display 6, as shown in FIG. 17.

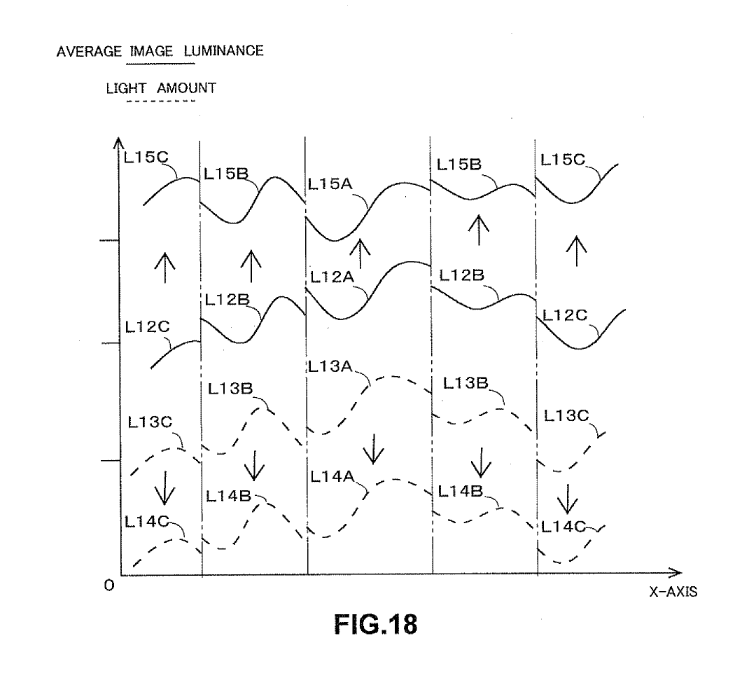

Further, the light amount determination part 17 determines a light amount L14A of each of the LEDs 5 derived after reduction by a predetermined proportion (e.g. 3%) from the determined light amount L13A in the first area A1, as shown in FIG. 18.

Concretely, the light amount determination part 17 derives the light amount L14A using the light amount L13A as a search key from a map where the light amount L13A and the light amount L14A are linked, the map being stored in the memory included in the on-vehicle apparatus 10 (twelfth search process).

Further, the light amount determination part 17 determines a light amount L14B of each of the LEDs 5 derived after reduction by a predetermined proportion (e.g. 6%) from the determined light amount L13B in the second area B1 and the second area B2, as shown in FIG. 18.

Concretely, the light amount determination part 17 derives the light amount L14B using the light amount L13B as a search key from a map where the light amount L13B and the light amount L14B are linked, the map being stored in the memory included in the on-vehicle apparatus 10 (thirteenth search process).

The light amount determination part 17 also determines a light amount L14C of each of the LEDs 5 derived after reduction by a predetermined proportion (e.g. 9%) from the determined light amount L13C in the third area C1 and the third area C2, as shown in FIG. 18.

Concretely, the light amount determination part 17 derives the light amount L14C using the light amount L13C as a search key from a map where the light amount L13C and the light amount L14C are linked, the map being stored in the memory included in the on-vehicle apparatus 10 (fourteenth search process).

Here, the four processes to be implemented by the light amount determination part 17, the eleventh search process, the twelfth search process, the thirteenth search process, and the fourteenth search process, may be integrated into one process.

That is, the light amount determination part 17 determines the light amount L14A, the light amount L14B, and the light amount L14C of each of the LEDs 5 based on the average image luminance L12A, the average image luminance L12B, and the average image luminance L12C at each position on the horizontal axis on the car navigation image G1 corrected by the image correction part 16, as shown in FIG. 18.

Concretely, the light amount determination part 17 derives the light amount L14A, the light amount L14B, and the light amount L14C using the average image luminance L12A, the average image luminance L12B, and the average image luminance L12C as search keys from a map where the average image luminance and the amounts of light are linked, the map being stored in the memory included in the on-vehicle apparatus 10.

That is, the light amount determination part 17 determines the control amount for each of the LEDs 5 included in the backlight 4 as shown in FIG. 16 as follows; the light amount L14A is used for the amounts of light of the LEDs 5 from an LED 5I to an LED 5M, the light amount L14B is for the LEDs 5 from an LED 5E to an LED 5H and from an LED 5N to an LED 5Q, and the light amount L14C is for the LEDs 5 from an LED 5A to an LED 5D and from an LED 5R to an LED 5U. Next, the process moves to a step S26.

In the step S26, the image correction part 16 implements a second-image-correction process. That is, the image correction part 16 determines an average image luminance L15A, an average image luminance L15B and an average image luminance L15C at each position on the horizontal axis on the car navigation image G1 based on the light amount L14A, the light amount L14B, and the light amount L14C of each of the LEDs 5 determined by the light amount determination part 17, as shown in FIG. 18.

Concretely, the image correction part 16 derives the average image luminance L15A, the average image luminance L15B and the average image luminance L15C using the light amount L14A, the light amount L14B, and the light amount L14C as search keys from a map where the average image luminance and the amounts of light are linked, the map being stored in the memory included in the on-vehicle apparatus 10 (fifteenth search process). The map is formed so that an image can provide visibility like the original car navigation image G1 as a whole by increasing the luminance of the image corresponding to the reduction in the amounts of light from the light amount L13A to the light amount L14A, from the light amount L13B to the light amount L14B, and the light amount L13C to the light amount L14C, based on respective functions of an image controller 13.

Further, since each of the average image luminance L15A, the average image luminance L14B and the average image luminance L15C is the average image luminance of the vertical direction at each position on the horizontal direction (X-axis direction) on the car navigation image G1 including the first area A1, the second area B1, the second area B2, the third area C1 and the third area C2 to be displayed on the screen of the display 6, the image correction part 16 needs to correct the luminance allotted to each of the pixels of the vertical direction based on respectively the average image luminance L15A, the average image luminance L15B and the average image luminance L15C of the vertical direction (average image luminance correction).

That is, the image correction part 16 implements correction on each of the pixels of the vertical direction at each position on the horizontal axis on the car navigation image G1 in such a manner that, when the luminance is low respectively based on the average image luminance (the average image luminance L15A, the average image luminance L15B or the average image luminance L15C) corresponding to each of the pixels, the luminance is increased by a predetermined proportion (%) in accordance with the differential, and when the luminance is high respectively based on the average image luminance, the luminance is reduced by a predetermined proportion (%) which is corresponding to the differential. Next, the process moves to a step S27.

In the step S27, the image controller 13 controls the backlight 4 based on the amounts of light determined by the light amount determination part 17. That is, the image controller 13 controls the LEDs 5 from the LED 5I to the LED 5M included in the backlight 4 to conform to the light amount L14A, as shown in FIG. 16. The image controller 13 also controls the LEDs 5 from the LED 5E to the LED 5H and from the LED 5N to the LED 5Q to conform to the light amount L14B, as shown in FIG. 16. The image controller 13 also controls the LEDs 5 from the LED 5A to the LED 5D and from the LED 5R to the LED 5U to conform to the light amount L14C, as shown in FIG. 16. Next, the process moves to a step S28.

In the step S28, the image controller 13 controls a TFT 3 to display the car navigation image G1 corrected by the image correction part 16 on the display 6. That is, the image controller 13 makes the light of the backlight 4 pass through one of the three RGB primary colors printed on each of the pixels of a color filter 1 by controlling the TFT 3 so that the display 6 displays the car navigation image G1. Next, the process moves to a return.

As above, in the third embodiment, the on-vehicle apparatus 10 displays the car navigation image G1 in a manner that the amount of light in the second area of the backlight 4 is lower than that in the first area, and further, the amount of light in the third area is lower than that in the second area. Thus, the on-vehicle apparatus 10 can reduce the current consumption even by sacrificing some of the visibility of the second area and the third area having relatively less importance, while keeping the fine visibility for a user of the first area which includes the own-vehicle position mark J on the car navigation image G1 and which is a relatively-important area.

Further, the on-vehicle apparatus 10 succeeds in recovering the some sacrificed visibility and keeping the fine visibility as a whole on the car navigation image G1 by correcting the luminance of the image corresponding to the reduced amounts of light of the backlight 4.

This makes it possible to reduce the current consumption of the backlight 4, while fulfilling the car navigation function.

### Modification

The embodiments of this invention were hereinbefore described. However, this invention is not limited to the embodiments described above, and various modifications can be implemented. Every embodiment described above and below can be optionally combined with others.

### Modification 1

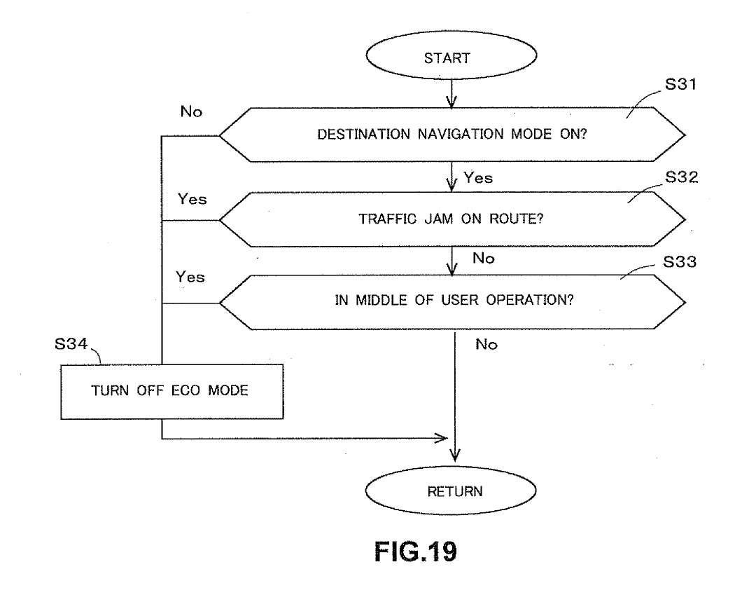

The controls implemented in the embodiments described above may be implemented only when specific conditions are fulfilled. Hereafter, the cases where specific conditions are fulfilled are described based on FIG. 19. The control flow shown in FIG. 19 is implemented at predetermined intervals after a user turns on an on-vehicle apparatus 10 and the on-vehicle apparatus 10 receives the user operation of turning on an eco mode via a touch panel unless the on-vehicle apparatus 10 receives the user operation of turning off the eco mode or of turning off the power.

In a step S31, an image controller 13 judges whether or not the image displayed on a display 6 is a car navigation image G1 and whether or not navigation function of route guidance to a destination is on. When the navigation function is not on (No at the step S31), the process moves to a step S34 and a controller 11 turns off the eco mode. When the navigation function is on (Yes at the step S31), the process moves to a step S32.

That is, when the navigation function is not on, the image controller 13 turns off the eco mode that a user has set on. As a result, a backlight 4 that lights the screen displaying the car navigation image G1 is controlled in a normal way.

When the navigation function is not on (that is, when a user does not set a destination), it is predicted that a user often confirms various information such as the current location of the vehicle, a map of the area, and facilities of the area while driving. Thus, in this case, since all the information shown on the car navigation image G1 is deemed important for a user, whole part of the screen providing all the information is displayed in fine visibility for a user.

In the step S32, the image controller 13 judges whether or not there is a traffic jam in a traveling direction on a route R based on traffic information received via VICS receiver. When there is a traffic jam (Yes at the step S32), the process moves to the step S34 and the image controller 13 turns off the eco mode. When there is no traffic jam (No at the step S32), the process moves to a step S33.

That is, when there is a traffic jam in the traveling direction on the route R, the image controller 13 turns off the eco mode that a user has set on. As a result, the backlight 4 that lights the screen displaying the car navigation image G1 is controlled in a normal way.

When there is a traffic jam in the traveling direction on the route R, it is predicted that a user may want to see the whole of the car navigation image G1 for considering various issues, such as searching another route to a destination or a place to have a rest such as a convenience store or a gas station. In this case, since the whole of the information shown on the car navigation image G1 is deemed important for a user, upgraded visibility on the whole of the screen displaying the whole of the information provides more convenience to a user.

In the step S33, the controller 11 judges whether or not a user is in the middle of operating marks that receive instructions for performing various functions via a touch panel 7. When the controller 11 judges that the marks are being operated by a user (Yes at the step S33), the process moves to the step S34 and the controller 11 turns off the eco mode. When the controller 11 judges that the marks are not being operated by a user (No at the step S33), the process moves to a return.

That is, when a user is in the middle of operating the marks, the image controller 13 turns off the eco mode that the user has set on, and the backlight 4 that lights the screen displaying the car navigation image G1 is controlled in a normal way.

The period when the marks are being operated by a user is the case where the controller 11 receives a user operation of the marks via the touch panel 7 repeatedly within a predetermined period (e.g. 4 seconds) after the user operated the marks previously.

The period when the user is in the middle of touching the marks on the touch panel 7 is a state where the screen is about to display new information corresponding to the touched mark, or where the user may operate another mark.

In this situation, the user wants to look at the whole of the car navigation image G1. Thus, when the controller 11 receives a user operation of the marks repeatedly within a predetermined period after a user operated the marks previously, since the whole of the information shown on the car navigation image G1 is deemed important for a user, upgraded visibility on the whole of the screen displaying the whole of the information provides more convenience to a user by controlling the backlight 4 in a normal way.

### Modification 2

In the third embodiment described above, the area having a constant width centered on the own-vehicle position mark is specified as the first area. However, a size of a part in a traveling direction of a vehicle in a first area may be specified greater than a size of an opposite part from the traveling direction of the vehicle.

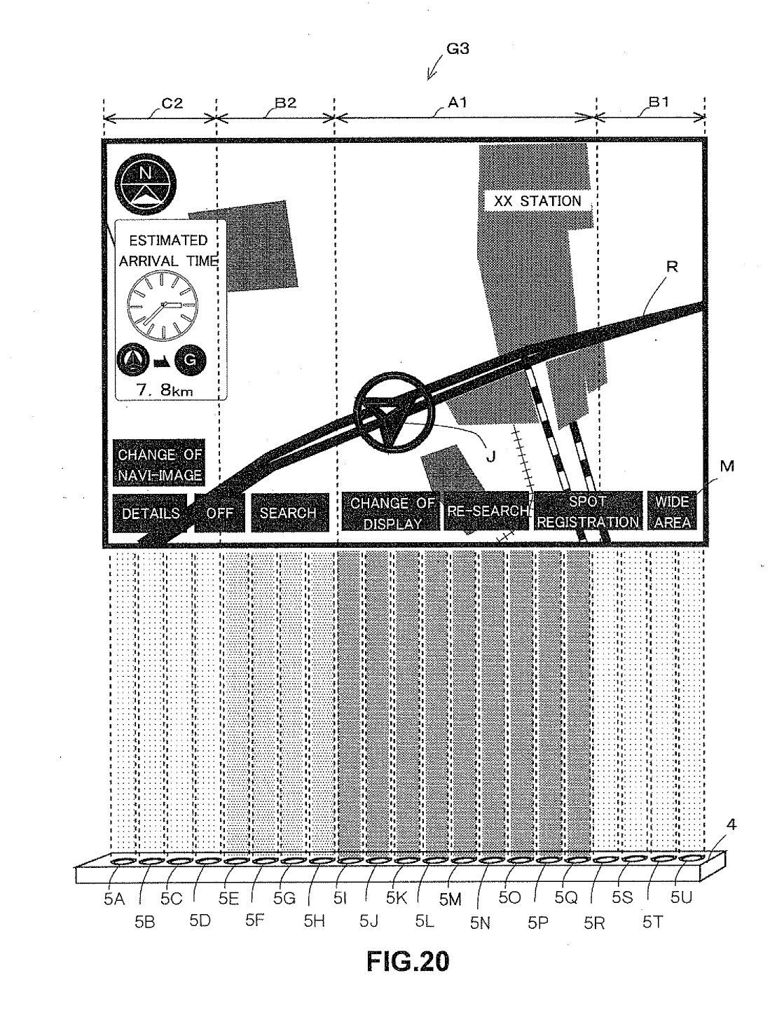

In an example, a first area A1 shown in FIG. 20 is spread in the right part in the traveling direction pointed by an own-vehicle position mark.

In this case of an on-vehicle apparatus 10, the image luminance in a second area B1 and a second area B2 that are specified on both the outer sides of the first area A1 is reduced so that the reduction amount of the image luminance in the second area B1 and the second area B2 becomes greater compared to the first area A1. Further, in the on-vehicle apparatus 10, the image luminance in a third area C2 that is specified on the outer side of the second area B2 is reduced so that the reduction amount of the image luminance in the third area C2 becomes greater that of the luminance of the image in the second area B2. This reduces the amounts of light in the second area B1 and the second area B2 of a backlight 4, and reduces further the amounts of light in the third area C2 of the backlight 4. Besides, the luminance of the image in those areas where the amounts of light are reduced is increased for correction based on the processes of the third embodiment described above.

The area in the traveling direction pointed by an own-vehicle position mark J on a car navigation image G3 is relatively important for a user. These processes ensure fine visibility for a user in such an important area. These processes also reduce the current consumption of the on-vehicle apparatus 10 by reducing the amounts of light of the backlight 4 lighting the area other than the first area A1.

### Modification 3

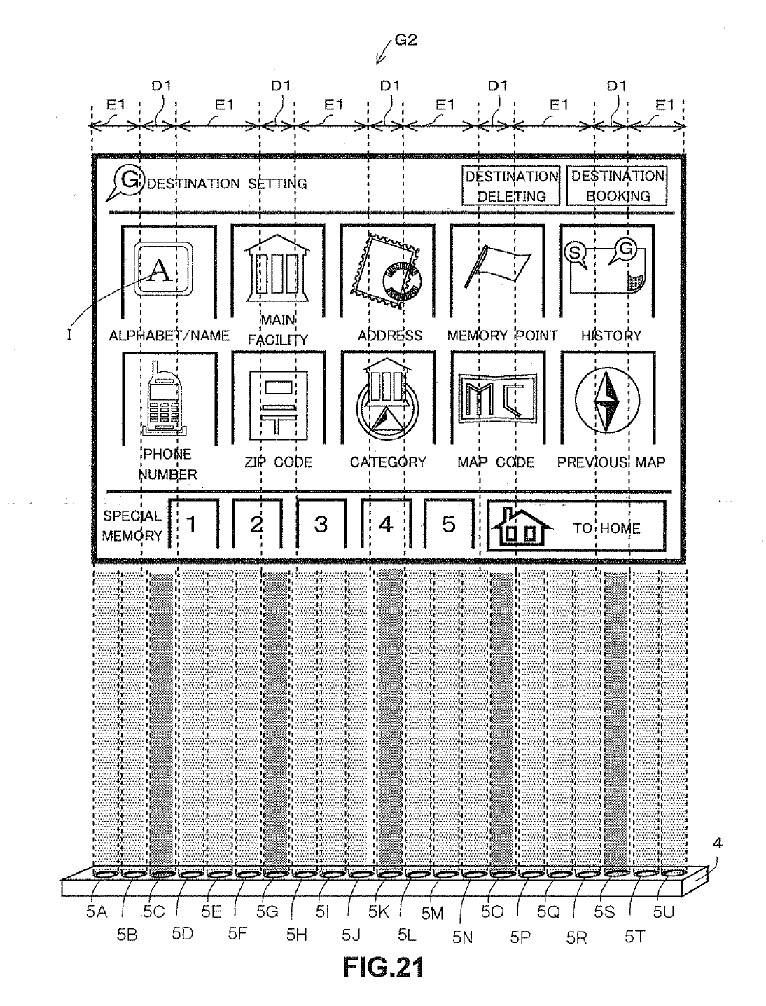

In the third embodiment described above, the car navigation image G3 is used as an illustration image. A menu image G2 shown in FIG. 21 may also be used as an illustration image.

The menu image G2 displays a plurality of selection marks I corresponding to a plurality of functions respectively. Each of the selection marks is to receive a user instruction for implementing a responding function.

An image analyzer 14 judges where each of the selection marks I included in the menu image G2 is displayed on the menu image G2. The image analyzer 14 specifies a selection mark area D1 having a constant width centered on one of the selection marks 1, and also specifies a non-selection mark area El that is the area other than the selection mark area D1, as shown in FIG. 21. The menu image G2 as shown in FIG. 21 has the plurality of selection marks I in various sizes, big and small. Thus, if the selection mark area D1 is specified for each of the selection marks I, all of the LEDs 5 included in the backlight 4 are ultimately to be controlled so as to emit light evenly.

Thus, in the case of the menu image G2, the selection mark area D1 and the non-selection mark area E1 other than the selection mark area D1 are defined, and the image analyzer 14 specifies the selection mark area D1 centered on a selection mark. The selection mark area D1 is defined as the area for the biggest-sized mark or the area having a constant width centered on the selection mark for directly executing the purpose of the menu image G2, for example. Looking at FIG. 21, the area having a constant width of an “ALPHABET/NAME” mark or a “MAIN FACILITY” mark corresponds to the selection mark area D1 of the biggest-sized marks. The area having a constant width of an “ALPHABET/NAME” mark or a “MAIN FACILITY” mark also corresponds to the selection mark area D1 of the selection mark for directly executing the purpose of the menu image G2 because the purpose of the menu image G2 is to set the destination. The non-selection mark area E1 is defined as the area other than the selection mark area D1, for example.

Here, the amounts of light determined by a light amount determination part 17 of an image controller 13 or by other parts, and the amounts of light of the backlight 4 to be controlled by a controller 11 are determined and controlled in the same manner that they are done in the first area A1 and the second area B1 of the third embodiment described above.

This reduces the luminance of the image in the non-selection mark area E1 so that the reduction of the image luminance in the non-selection mark area E1 becomes large compared to that in the selection mark area D1. As a result, the selection mark area D1 centered on one of the selection marks I that is an important indication on the menu image G2 is displayed brightly, and the non-selection mark area E1 that is a relatively-less important area is displayed darker than the selection mark area D1. However, the menu image G2 as a whole ensures the function to provide menu information to a user. That is, an on-vehicle apparatus 10 succeeds in reducing the current consumption while fulfilling the function providing selections on the menu image G2.

### Modification 4

In the embodiments described above, an illustration image such as a car navigation image or a menu image is a subject to be corrected. This is just because it is found that the correction described above is effective especially on the image having less low-luminance area. The correction described above may also be implemented in a non-illustration image.

In an example, a display apparatus includes a low-luminance area judgment part instead of the illustration image judgment part described in the above embodiments. The low-luminance area judgment part has a function of judging whether or not an image has a low-luminance area more than a predetermined proportion. When the low-luminance area judgment part judges that the image has a low-luminance area more than the predetermined proportion, an image controller 13 implements the correction described above. This ensures the same effects as the one described above.

While the invention has been shown and described in detail, the foregoing description is in all aspects illustrative and not restrictive. It is therefore understood that numerous other modifications and variations can be devised without departing from the scope of the invention.

What is claimed is:

1. A display apparatus that displays an image, the display apparatus comprising:
a display that includes a screen;
a backlight that includes a plurality of light sources lighting the screen; and
a control system that: (i) implements a correction to reduce a luminance of an image to be displayed on the display; (ii) determines an amount of light of the backlight based on the reduced luminance of the image; and (iii) controls the backlight to conform to the amount of light determined based on the reduced luminance.

2. The display apparatus of claim 1, wherein the control system:
implements a further correction to increase the luminance of the image after determination of the amount of light of the backlight.

3. The display apparatus of claim 1, wherein the control system:
judges whether or not the image to be displayed is an illustration image, and
does not implement the correction to reduce the luminance in a case where the image to be displayed is not the illustration image.

4. The display apparatus of claim 1, wherein
the image to be displayed is a car navigation image used for navigation by a car navigation apparatus,
the car navigation image includes a first area having an own-vehicle position mark indicating a position of a vehicle and a second area that excludes the first area, and
the control system reduces a luminance of each of the first area and the second area so that a reduction amount of the luminance of the second area becomes greater than a reduction amount of the luminance of the first area.

5. The display apparatus of claim 4, wherein
a size of a part in a traveling direction of the vehicle from the own-vehicle position mark in the first area is greater than a size of an opposite part from the traveling direction of the vehicle from the own-vehicle position mark in the first area.

6. The display apparatus of claim 1, wherein
the image to be displayed is a menu image including a selection mark for receiving a user instruction,
the menu image has a first area having a selection mark and a second area that excludes the first area, and
the control system reduces the luminance of each of the first area and the second area so that a reduction amount of the luminance of the second area becomes greater than a reduction amount of the luminance of the first area.

7. A display method for displaying an image, the method comprising the steps of:
(a) implementing a correction to reduce a luminance of an image to be displayed on a screen of a display;
(b) based on the reduced luminance of the image after the correction, determining an amount of light of a backlight that includes a plurality of light sources, the backlight lighting the screen; and
(c) controlling the backlight to conform to the amount of light determined in step (b).

8. The display method of claim 7, further comprising the step of:
(d) implementing another correction to increase the luminance of the image corrected by step (a) after determination of the amount of light of the backlight in step (b).

9. The display method of claim 7, further comprising the steps of:
(e) judging whether or not the image to be displayed is an illustration image; and
(f) prohibiting the correction of step (a) in a case where the image to be displayed is not the illustration image.

10. The display method of claim 7, wherein
the image to be displayed is a car navigation image used for navigation by a car navigation apparatus, and
the car navigation image includes a first area having an own-vehicle position mark indicating a position of a vehicle and a second area that excludes the first area, and
step (a) reduces a luminance of each of the first area and the second area so that a reduction amount of the luminance of the second area becomes greater than a reduction amount of the luminance of the first area.

11. The display method of claim 10, wherein
a size of a part in a traveling direction of the vehicle from the own-vehicle position mark in the first area is greater than a size of an opposite part from the traveling direction of the vehicle from the own-vehicle position mark in the first area.

12. The display method of claim 7, wherein
the image to be displayed is a menu image including a selection mark for receiving a user instruction,
the menu image has a first area having a selection mark and a second area that excludes the first area, and
step (a) reduces the luminance of each of the first area and the second area so that a reduction amount of the luminance of the second area becomes greater than a reduction amount of the luminance of the first area.
